(19) United States
(12) Patent Application Publication
(10) Pub. No.: US 2017/0024326 A1
(43) Pub. Date: Jan. 26, 2017

(54) Method and Apparatus for Caching Flash Translation Layer (FTL) Table

(71) Applicants: Shanying Luo, Fremont, CA (US); Yiren Ronnie Huang, San Jose, CA (US)

(72) Inventors: Shanying Luo, Fremont, CA (US); Yiren Ronnie Huang, San Jose, CA (US)

(73) Assignee: CNEX-Labs, Inc., San Jose, CA (US)

(21) Appl. No.: 15/217,934

(22) Filed: Jul. 22, 2016

Related U.S. Application Data
(60) Provisional application No. 62/195,638, filed on Jul. 22, 2015.

(51) Int. Cl. G06F 12/1009; G06F 12/123; G06F 12/02; G06F 12/0891

(52) U.S. Cl. CPC G06F 12/1009; G06F 12/0891; G06F 12/123; G06F 12/0246; G06F 2212/1044; G06F 2212/222; G06F 2212/608; G06F 2212/7201; G06F 2212/7205; G06F 2212/69

(57) ABSTRACT

A solid-state drive (“SSD”) containing a non-volatile memory (“NVM”), flash translation layer (“FTL”) table, cache node index table, and random access memory (“RAM”) configured to cache at least a portion of the FTL table is disclosed. The NVM is organized its memory space into memory blocks for data storage wherein each of the memory blocks is further divided into a set of physical pages addressable by corresponding physical page addresses (“PPAs”). The FTL table, also known as address mapping table, includes multiple entries used for NVM memory accessing. Each entry of the FTL table stores a PPA addressing a physical page in the NVM. The RAM caches or stores a portion of the FTL table based on a table caching mechanism. The cache node index table resided in the RAM or RAM cache contains indexing information associated with the FTL table.

### PRIORITY

This application claims the benefit of priority based upon U.S. Provisional Patent Application having an application No. 62/195,638, filed on Jul. 22, 2015, and entitled “Method and Apparatus for Caching a Portion of Flash Translation Layer (FTL) Table in RAM,” which is hereby incorporated herein by reference in its entirety.

### FIELD

The exemplary embodiment(s) of the present invention relates to the field of semiconductor and integrated circuits. More specifically, the exemplary embodiment(s) of the present invention relates to non-volatile memory storage and devices.

### BACKGROUND

A typical solid-state drive (“SSD”), which is also known as a solid-state disk, is a data storage memory device for persistently remember stored information or data. Conventional SSD technology employs standardized interfaces or input/output (“I/O”) standards that may be compatible with traditional I/O interfaces for hard disk drives (“HDD”). For example, the SSD uses non-volatile memory components to store and retrieve data for a host system or a digital processing device via standard I/O interfaces.

To store data persistently, various types of non-volatile memories (“NVMs”) such as flash based or phase change memory (“PCM”) may be used. PCM, which is also known as PCME, PRAM, PCRAM, Chalcogenide RAM, or ovonic unified memory, may use its state between the crystalline and amorphous state to store information. For instance, an amorphous state may indicate logic 0 with high resistance while a crystalline state may indicate logic 1 with low resistance.

The conventional flash memory capable of maintaining, erasing, and/or reprogramming data can be fabricated with several different types of integrated circuit (“IC”) technologies such as NOR or NAND logic gates with floating-gates. Depending on the applications, a typical memory access of flash memory can be configured to be a block, a page, a word, and/or a byte. To properly map or translate between a logical block address (“LBA”) of a host device and a physical page address (“PPA”) of flash memory, a flash translation layer (“FTL”) table is used for address mapping. The FTL table is typically a flash file system. With increasing in NVM storage capacity, the size of FTL table is also increased accordingly. The LBA is used to address a block of data seeing by an input and output (“IO”) device of SSD while PPA addresses a physical storage location where the data is actually stored.

A drawback, however, associate with FTL or FTL database or FTL table is that it takes time to search the FTL table due to its large size. Also, managing data loss and/or data recovery in FTL table due to unexpected power loss can be challenging.

### SUMMARY

One embodiment of the present invention discloses a solid-state drive (“SSD”) containing a non-volatile memory (“NVM”), flash translation layer (“FTL”) table, cache node index table, and random access memory (“RAM”) configured to cache at least a portion of the FTL table. In one aspect, the NVM is organized its memory space into memory blocks for data storage wherein each of the memory blocks is further divided into a set of physical pages addressable by corresponding physical page addresses (“PPAs”). The FTL table, also known as address mapping table, includes multiple entries used for NVM memory accessing. Each entry of the FTL table stores a PPA addressing a physical page in the NVM. The RAM caches or stores a portion of the FTL table based on a table caching mechanism. The cache node index table, also known as FTL index table, resided in the RAM or RAM cache contains indexing information associated with the FTL table.

Additional features and benefits of the exemplary embodiment(s) of the present invention will become apparent from the detailed description, figures and claims set forth below.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a storage device configured to cache FTL table in accordance with one embodiment of the present invention;

FIG. 2 is a block diagram illustrating a storage system caching FTL tables between RAM and NVM in accordance with one embodiment of the present invention;

FIG. 3 is a block diagram illustrating a configuration of NVM using FTL table cache operation for fast memory access in accordance with one embodiment of the present invention;

FIG. 4 is a block diagram illustrating an exemplary FTL index table used in FTL caching operation in accordance with one embodiment of the present invention;

FIGS. 5-6 are block diagrams illustrating exemplary lists for FTL caching operation in accordance with one embodiment of the present invention;

FIG. 7 is a diagram illustrating an NVM storage device configured to quickly store and/or recover FTL database using an FTL index table in accordance with one embodiment of the present invention;

FIG. 8 is a logic diagram illustrating a NVM memory process via cached FTL table entries with a set of FTL cache status bits in accordance with one embodiment of the present invention;

FIG. 9 is a block diagram illustrating a NVM memory containing a storage area and an extended storage area in accordance with one embodiment of the present invention;

FIG. 10 is a flow diagram illustrating a cache operation for FTL table in accordance with embodiments of the present invention; and

FIG. 11 shows an exemplary embodiment of a digital processing system connecting to an SSD using FTL table caching operation in accordance with the present invention.

### DETAILED DESCRIPTION

Exemplary embodiments of the present invention are described herein in the context of a methods, system and apparatus of facilitating a cache operation for address mapping table in NVM or NVM device(s).

Those of ordinary skills in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of this disclosure.

In accordance with the embodiment(s) of present invention, the components, process steps, and/or data structures described herein may be implemented using various types of operating systems, computing platforms, computer programs, and/or general purpose machines. In addition, those of ordinary skills in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, PCM, Jump Drive, and the like), magnetic storage medium (e.g., tape, magnetic disk drive, and the like), optical storage medium (e.g., CD-ROM, DVD-ROM, paper card and paper tape, and the like), phase change memory (“PCM”) and other known types of program memory.

The term “system” is used generically herein to describe any number of components, elements, sub-systems, devices, packet switch elements, packet switches, routers, networks, computer and/or communication devices or mechanisms, or combinations of components thereof. The term “computer” is used generically herein to describe any number of computers, including, but not limited to personal computers, embedded processors and systems, control logic, ASICs, chips, workstations, mainframes, etc. The term “device” is used generically herein to describe any type of mechanism, including a computer or system or component thereof. The terms “task” and “process” are used generically herein to describe any type of running program, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the figures, including, but not limited to the block and flow diagrams, are typically performed in a different serial or parallel ordering and/or by different components and/or over different connections in various embodiments in keeping within the scope and spirit of the invention.

The term communications network, network, or IP communication network generally refers to any type of network having an access network capable of transmitting data in the form of cells, for example of ATM (Asynchronous Transfer Mode) type, on a transport medium, for example of the TCP/IP or UDP/IP type. The network or IP network can be a satellite network such as a DVB-RCS (Digital Video Broadcasting-Return Channel System) network, SDMB (Satellite Digital Multimedia Broadcast) network, terrestrial network, cable (xDSL) network, or mobile/cellular network type including the evolution of the UMTS known as LTE (Long Term Evolution) network.

One embodiment of the present invention discloses a solid-state drive (“SSD”) containing a non-volatile memory (“NVM”), flash translation layer (“FTL”) table, cache node index table, and random access memory (“RAM”) configured to cache at least a portion of the FTL table. In one aspect, the NVM is organized its memory space into memory blocks for data storage wherein each of the memory blocks is further divided into a set of physical pages addressable by corresponding physical page addresses (“PPAs”). The FTL table, also known as address mapping table, includes multiple entries used for NVM memory accessing. Each entry of the FTL table stores a PPA addressing a physical page in the NVM. The RAM caches or stores a portion of the FTL table based on a table caching mechanism. The cache node index table, also known as FTL index table, resided in the RAM or RAM cache contains indexing information associated with the FTL table.

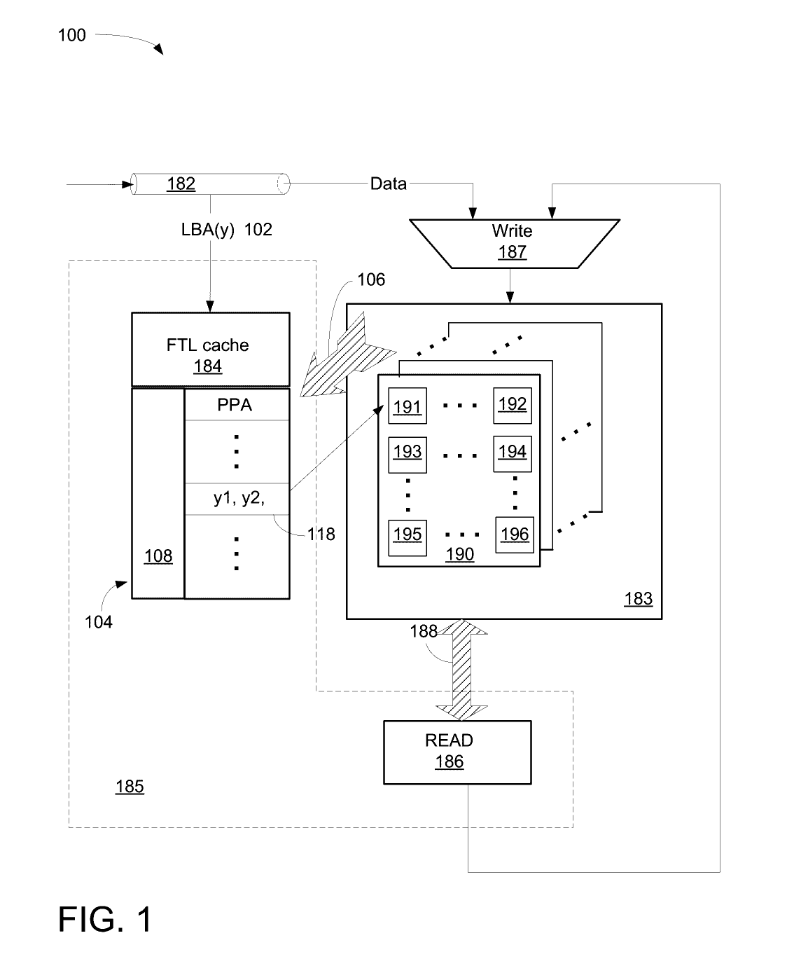

FIG. 1 is a block diagram 100 illustrating a storage device configured to cache FTL table in accordance with one embodiment of the present invention. The terms NV storage, NVM device, and NVM array are referred to a similar non-volatile memory apparatus and they can be used interchangeably. Diagram 100 includes input data 182, NVM device 183, output port 188, and storage controller 185. Storage controller 185 can also be referred to as memory controller, controller, and storage memory controller, and they can be used interchangeably hereinafter. Controller 185, in one embodiment, includes read module 186, write module 187, FTL cache 184, LBA-PPA address mapping component 104, and FTL cache circuit (“FCC”) 108. A function of FTL cache 184 is to map logical block addresses (“LBAs”) to physical page addresses (“PPAs”) when a command of memory access is received. It should be noted that the underlying concept of the exemplary embodiment(s) of the present invention would not change if one or more blocks (or devices) were added to or removed from diagram 100.

A flash memory based storage device such as SSD, for example, includes multiple arrays of flash memory cells for storing digital information. The flash memory, which generally has a read latency less than 100 microseconds (“μs”), is organized in blocks and pages wherein a page is a minimum writeable unit or MWU. In one example, a page may have four (4) kilobyte (“Kbyte”), eight (8) Kbyte, or sixteen (16) Kbyte memory capacity depending on the technology and applications. It should be noted that other types of NVM, such as phase change memory (“PCM”), magnetic RAM (“MRAM”), STT-MRAM, or ReRAM, can have similar storage organization as the flash memory. To simplify the forgoing discussion, the flash memory is used as an exemplary NVM device. Also, a page or flash memory page (“FMP”) with 4 Kbyte is used as an exemplary page size.

NVM device 183 includes multiple blocks 190 wherein each block 190 is further organized to multiple pages 191-196. Each page such as page 191 can store 4096 bytes or 4 Kbyte of information. In one example, block 190 can contain from 128 to 512 pages or sectors 191-196. A page, in this example, is a minimal writable unit which can persistently retain information or data for a long period of time without power supply.

FTL cache 184, in one embodiment is implemented in RAM or DRAM (dynamic random access memory) and includes a portion of the FTL database or table entries configured to store information relating to address mapping. For example, the size of FTL database is generally a positive proportion to the total storage capacity of NVM. To implement the FTL table, memory controller 185 or FCC 108, in one aspect, allocates a portion of DRAM or RAM having a cache size that is capable of storing a portion of the FTL table wherein the entire FTL table is saved in the NVM. Note that the storage size of FTL table is approximately equal to 1/1000 of the total NVM capacity.

Memory controller 185, in one embodiment, manages FTL cache 184, write module 187, read module 186, mapping component 104, and FCC 108. Mapping component 104, which can be part of FTL cache 184, is configured to facilitate address translation between logical address used by a host system and physical address used by NVM device. For example, LBA(y) 102 provided by the host system may be mapped to PPA 118 pointing to a PPA in the NVM device based on a predefined address mapping algorithm.

To improve access speed to the FTL table, a portion of the FTL table or a portion of the FTL entries is cached using DRAM or RAM so that the search time or access time to the FTL table may be reduced. Caching a portion of the FTL table can also improve data loss due to unexpected power loss. FCC 108, in one embodiment, is used to maintain FTL cache 184 to determine which portion of the FTL table in NVM should be cached to RAM as indicated by numeral 106. FCC 108, in one example, employs the least recently used (“LRU”) like or linked list for the FTL cache page swap. FCC 108 also provides data synchronization between the content in the FTL cache pages in RAM and the content in the FTL pages in NVM.

The FTL cache pages located in RAM is operable to store a portion of FTL table or a set of entries in the FTL table. The FTL pages located in NVM is used to store entire FTL tables persistently. To swap out content of FTL cache pages in the RAM for making storage space for caching operation, the swapped out content, in one example, needs to be synchronized with the corresponding content stored in the FTL pages in the NVM. The content of the swapped out FTL cache page(s) is merged with the content of FTL page and subsequently store the merged content back to the FTL page.

In operation, upon receipt of data input or data packets 182, FTL cache 184 maps LBA(y) 102 to a PPA in a cache hit situation. After identifying the PPA via FTL cache 184, write circuit 187 writes the data from data packets 182 to a page or pages pointed by the PPA in NVM 193. After storing data in a block such as block 190, cache hit information is updated by FCC 108. Note that the data stored in NVM or storage device 183 may be periodically refreshed using read and write modules 186-187.

Upon occurrence of unintended system power down or crash, the FTL cache page containing the recent updates of mapping information could be lost if it is not properly saved. In one embodiment, the FTL cache pages in DRAM are quickly stored in a predefined section of NVM before the power terminates. Upon recovery of NVM device 183, FTL cache or cache page 184 can be restored or recovered. In one embodiment, a technique of FTL snapshot with FTL index table is used for FTL cache restoration.

An advantage of employing FTL cache is that it can enhance overall NVM efficiency and data integrity.

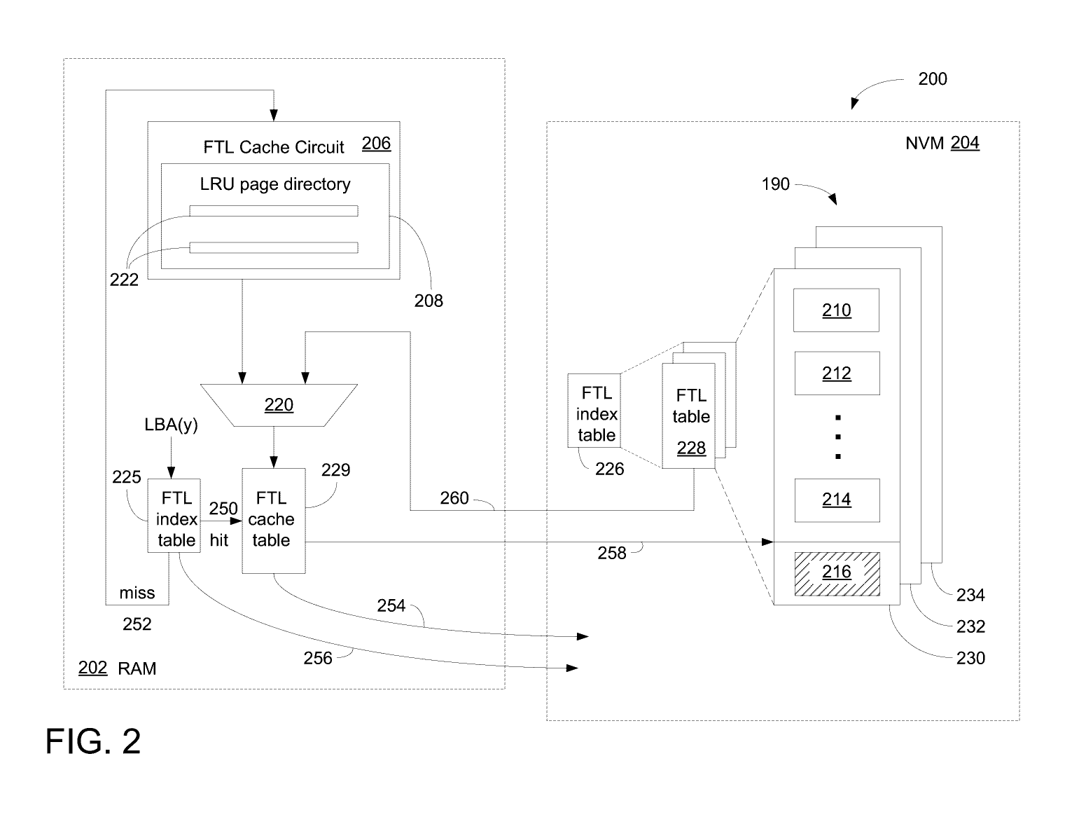

FIG. 2 is a block diagram 200 illustrating a storage system caching FTL tables between RAM and NVM in accordance with one embodiment of the present invention. Diagram 200 shows a digital processing system such as an SSD having RAM 202 and NVM 204. The SSD, in one example, is further includes a memory controller capable of facilitating and/or caching one or more FTL table pages for improving efficiency of overall SSD performance. It should be noted that the underlying concept of the exemplary embodiment(s) of the present invention would not change if one or more blocks (or devices) were added to or removed from diagram 200.

NVM 204, in one aspect, is organized its memory space into multiple memory blocks 230-234 for storing data persistently. Each of the memory blocks is further divided into a set of physical pages 210-216 which are addressable by the corresponding physical page addresses (“PPAs”). Note that NVM 204 can be a flash memory based storage device, PCM based memory, or a combination of flash and PCM based memory.

FTL table 228, which is also known as an address mapping table, is situated in NVM 204. FTL table 228, in one aspect, is organized to include multiple entries used to access memory blocks and/or pages. Each entry of FTL table 228 contains at least one address that points or indexes to a physical page within the NVM. In one example, FTL table is considered as a PPA to LBA mapping table used to associate between PPAs and LBAs for memory operation.

NVM 204 further includes a cache node index table or FTL index table 226. FTL index table 226 is organized to have multiple entries used to index or reference FTL tables 228. For example, while the entries of FTL table are stored in various physical pages or FTL pages such as page 216 in NVM 204, FTL index table 226 is used to index corresponding FTL pages based on LB As. A purpose of using FTL index table such as table 226 is to efficiently or quickly locate corresponding entries in FTL table 228 whereby a PPA can be obtained in time for storage.

RAM, DRAM, or RAM cache 202 logically coupled to NVM 204 is configured to cache at least a portion of FTL table 228 based on a table caching mechanism. RAM 204, in one embodiment, includes FTL cache circuit or FCC 206, FTL cache table 229, and FTL index cache table 225. FTL index cache table 225 includes a copy of FTL index table 226 in NVM 204. It should be noted that FTL index table 225 may be updated wherein the updated FTL index table 225 may be stored back to FTL index table 226 as indicated by numeral 256. FTL cache table 229 stores at least a portion of FTL table 228. In one example, FTL cache table 229 may contain more recently updated information than the information stored in the corresponding entry(s) of FTL table 228. FCC 206, in one embodiment, determines which portion of FTL table 228 should be loaded into FTL cache table 229.

FCC 206, in one embodiment, includes LRU page directory 208 wherein directory 208 includes LRU lists or LRU linked lists 222. A function of FCC 206 is to facilitate page swapping between NVM pages dedicated to FTL table 228 and RAM pages dedicated to FTL cache table 229. In one aspect, LRU page directory 208 includes a hot LRU list and a cold LRU list wherein the hot LRU list includes the recently referenced FTL cache pages. The cold LRU list includes less referenced FTL cache pages for storing entries associated to FTL table. Alternatively, LRU page directory 208 further includes a garbage collection (“GC”) LRU list which refers to the GC RAM pages referenced by a GC process. In another embodiment, LRU page directory 208 further includes a warm LRU list configured to include RAM pages or FTL cache pages recently referenced by a host. In operation, the last node on the hot LRU list becomes the front or head node of the cold LRU list when the last node of the hot LRU list is swapped out. A function of swapping out a cache page is that the swapping out function makes storage room or space in an LRU list to accommodate newly arrived node(s).

The SSD further includes a memory controller, not shown in FIG. 2, coupled to NVM 204, that manages FTL tables 228-229. The memory controller is also capable of facilitating a process of garbage collection to recycle stale pages into free pages in accordance with various triggers, such as programming cycle count, minimum age of a block, and/or parity check.

In operation, upon receipt of an incoming LBA, FTL cache index table 225 is searched to see if the relevant entries of FTL table are in FTL cache table 229. If the search result is a hit, the corresponding PPA of physical page is in FTL cache table 229, and the memory is accessed based on the PPA in FTL cache table 229. If, however, the search result is a miss, the correspond FTL page(s) containing entries of FTL table 228 according to the LBA is loaded into FTL cache table 229 via gate 220 and connection 260. The memory is subsequently accessed based on the PPA in the FTL cache table 229. If FTL cache table 229 needs to make room for new FTL pages from FTL table 228, the least referenced page(s) or least recently used page(s) in FTL cache table 229 is swapped out as indicated by numeral 254. It should be noted that the swapped out page(s) is subsequently stored back to FTL table 228. It should be noted that when the power is unexpectedly terminated, FTL index table 225 and FTL cache table 229 are quickly stored in NVM 204.

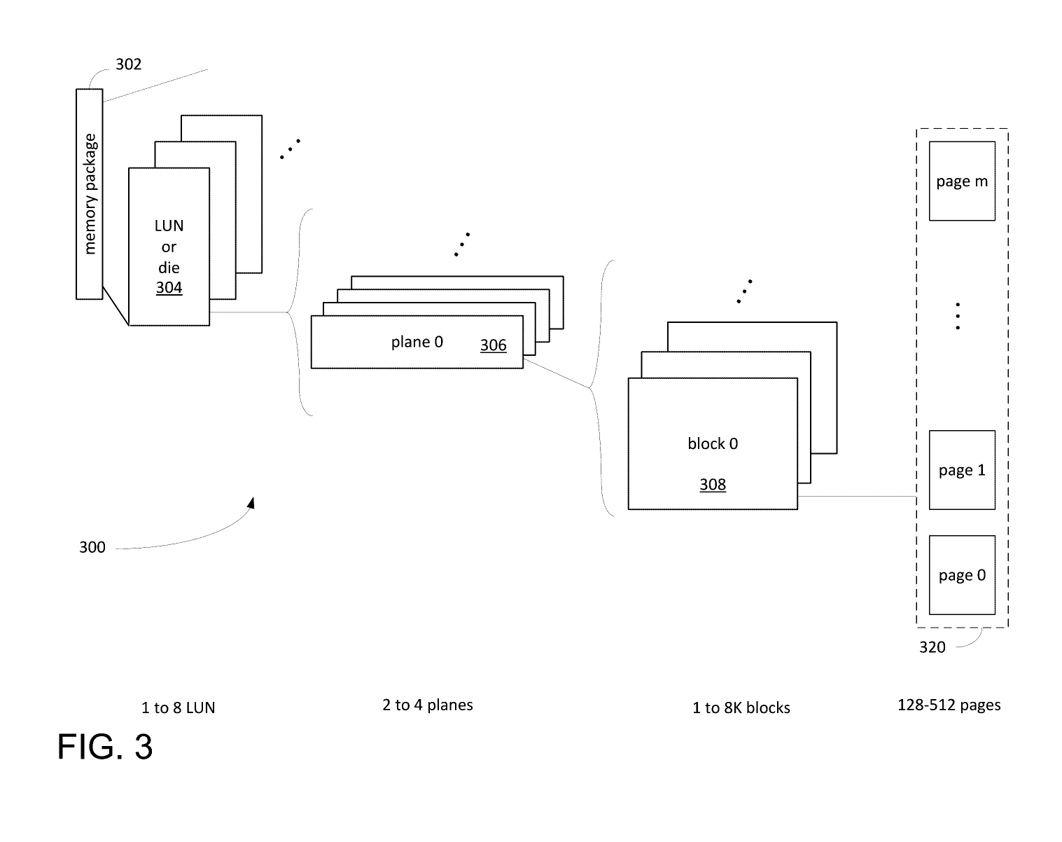

FIG. 3 is a block diagram 300 illustrating a configuration of NVM using FTL table cache operation for fast memory access in accordance with one embodiment of the present invention. Diagram 300 includes a memory package 302 which can be a memory chip containing one or more NVM dies or logic units (“LUNs”) 304. A flash memory, for example, has a hierarchy of Package-Silicon Die/LUN-Plane-Block-Flash Memory Page-Wordline configuration(s). It should be noted that the underlying concept of the exemplary embodiment(s) of the present invention would not change if one or more blocks (or devices) were added to or removed from diagram 300.

In one example, an NVM memory device such as a flash memory package 302 is generally organized with one or more flash memory dies or LUNs. Each LUN or die 304 can be further arranged into one or more NVM or flash memory planes 306. For example, die 304 may have a dual planes or quad planes. Each NVM or flash memory plane 306 can include multiple memory blocks or blocks 308. In one example, each plane 306 can be further organized into multiple blocks 308 which could have a range of 1000 to 8000 blocks. Each block such as block 308 may be arranged with a group of pages. A flash memory block can have multiple pages ranging from 256 to 512 pages as indicated by numeral 320.

In one aspect, one flash memory page can store anywhere between 8 and 64 kilobytes (“KB”) of data plus extra redundant area for ECC parity data. One flash memory block is the minimum unit of erase. One flash memory page is the minimum unit of program. To avoid marking an entire flash memory block bad or defective which will lose anywhere from 256 to 512 flash memory pages, a page removal or decommission can be advantageous. It should be noted that 4 Megabytes (“MB”) to 16 MB of storage space can be saved to move from block decommissioning to page decommissioning.

To access NVM efficiently, an FTL table is used. The FTL table contains multiple entries wherein each entry stores a PPA pointing to a physical page in NVM. An advantage of using NVM device having a configuration illustrated in diagram 300 is that the efficient memory access is achievable via the FTL cache operation.

One embodiment of the presently claimed invention discloses the SSD architecture capable of providing FTL table management including recovery and restoration. For example, to manage NVM, it can require a significant amount of RAM space to hold the entire content of a FTL table. Note that the complete FTL table is stored in NVM. To cache a portion of the FTL table from NVM to RAM, it can conserve memory space.

Each FTL entry contains one NVM physical address. When I/O request comes on one LBA, it needs search FTL table to locate the physical address or PPA in NVM according to the LBA. Note that not all of FTL table is in the RAM or cache. To find the location of the FTL table inside NVM, a smaller size of FTL index table is loaded into RAM. Each entry in the FTL index table points to a FTL page. From the FTL index table, system can quickly locate one FTL PPA based on the offset mechanism. Each FTL page contains multiple entries. For example, the range of entries can be from 1000 entries to 4000 entries. The FTL entry for the LBA access is within this FTL page, and system needs to load the LBA's FTL entry by set an offset.

To achieve a balance between performance and RAM usage for FTL table operation, a portion of the FTL table is kept with RAM wherein the FTL cache pages represent the most recently used FTL pages. When new I/O access come, system needs to search FTL index table and FTL cache RAM to see if the corresponding FTL entry is within FTL cache RAM. When cache-missing occurs, the system needs to read FTL index table and reads the missing FTL page from non-volatile memory into the cache RAM. When cache-hit occurs, system reads the FTL entry directly from FTL cache RAM.

Each cache page in RAM is equivalent to one FTL page in NVM. To quickly search the FTL entry inside the FTL cache, a cache node index table or FTL index table is implemented. In one embodiment, all FTL pages are mapped to this index table sequentially. This cache node index table is located in RAM for fast access. In one aspect, each cache node contains cache page identifier (“id”), previous cache node id, and next cache node id. If the cache page id is invalid, it is cache miss. Otherwise, it is cache hit. Since all nodes are located in RAM sequentially, system can quickly locate its corresponding cache node by using the address offset, and check if the node contains a valid cache page id.

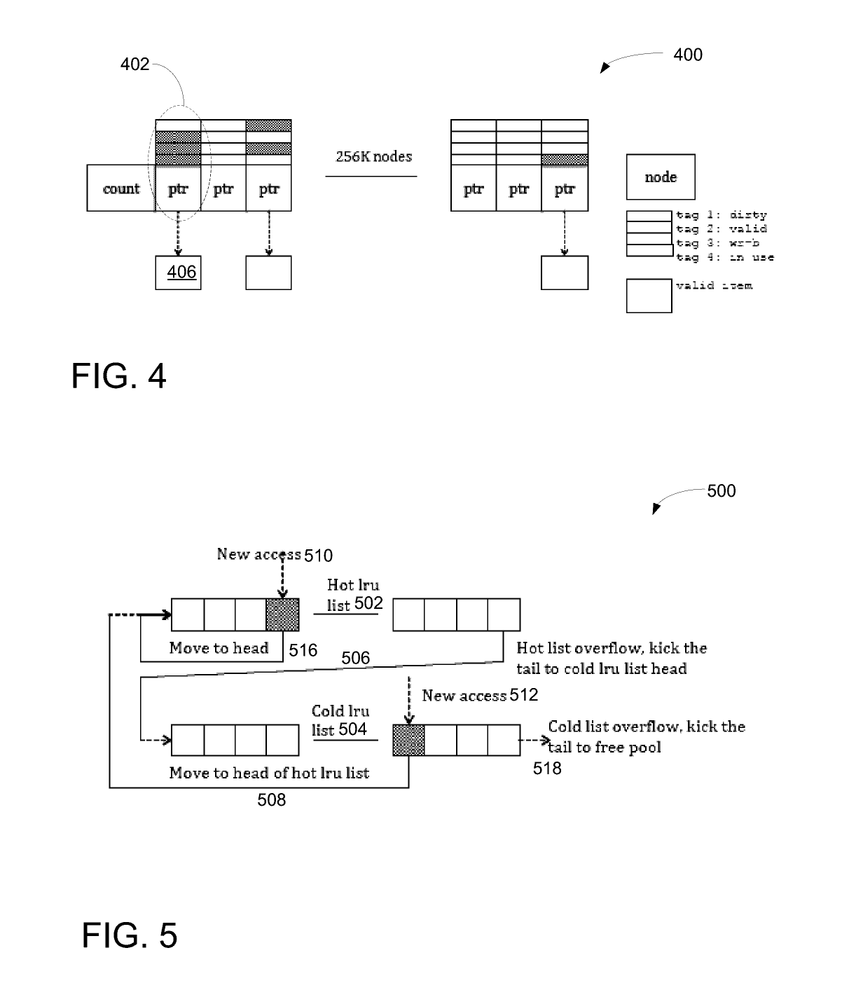

FIG. 4 is a block diagram 400 illustrating an exemplary FTL index table used in FTL caching operation in accordance with one embodiment of the present invention. Diagram 400 illustrates an FTL cache node index table or FTL index table organized in a set of linked nodes 402. In one aspect, the FTL index table is organized to be a 3-level radix tree for FTL cache node tags. Each node 402, containing tag information, is used to point to a page. In one example, node 402 of FTL index table points to a FTL cache page that may contain a PPA in accordance with received LBA. It should be noted that the underlying concept of the exemplary embodiment(s) of the present invention would not change if one or more blocks (or devices) were added to or removed from diagram 400.

Each node 402, for example, includes four (4) bits for four (4) tags, namely, dirty bit, valid bit, write-back bit, and in-use bit. A cache page can have multiple tag bits set for different purpose. For example, the dirty bit indicating “Dirty” means the cache page that has been updated. The valid bit indicating “Valid” means that the cache page contains the latest data from the FTL page saved in NVM. The write-back bit indicating “Write back” means that the cache page is in the process of being flushed into NVM. The in-use bit indicating “In use” means that it is being used by other module and not available for memory operation such as flush-out operation.

To quickly locate all FTL cache pages with dirty bits activated in the cache, a multi-level tree structure is used in node management for fast searching. When system needs to flush out all dirty FTL pages, the system checks the dirty bits starting from top of the tree as a radix tree search operation, and walking through every dirty leaf-node until all of the dirty bits are found. For one (1) terabyte (“TB”) capacity system, the system, for example, allocates one (1) gigabyte (“GB”) FTL data, or 256K FTL pages assuming 4K FTL page granularity. The search operation based on the radix tree as illustrated in diagram 400 can be implemented. Depending on the applications, a DDR memory with 128 MB storage capacity for radix tree (4˜5 MB) operation can be configured for fast searching operation.

An advantage of using the FTL index table for indexing the FTL table is that it allows fast offset lookup operation. For instance, a cache miss happens when a pointer inside the node structure points to a NULL. A cache hit happens when the pointer has a valid address.

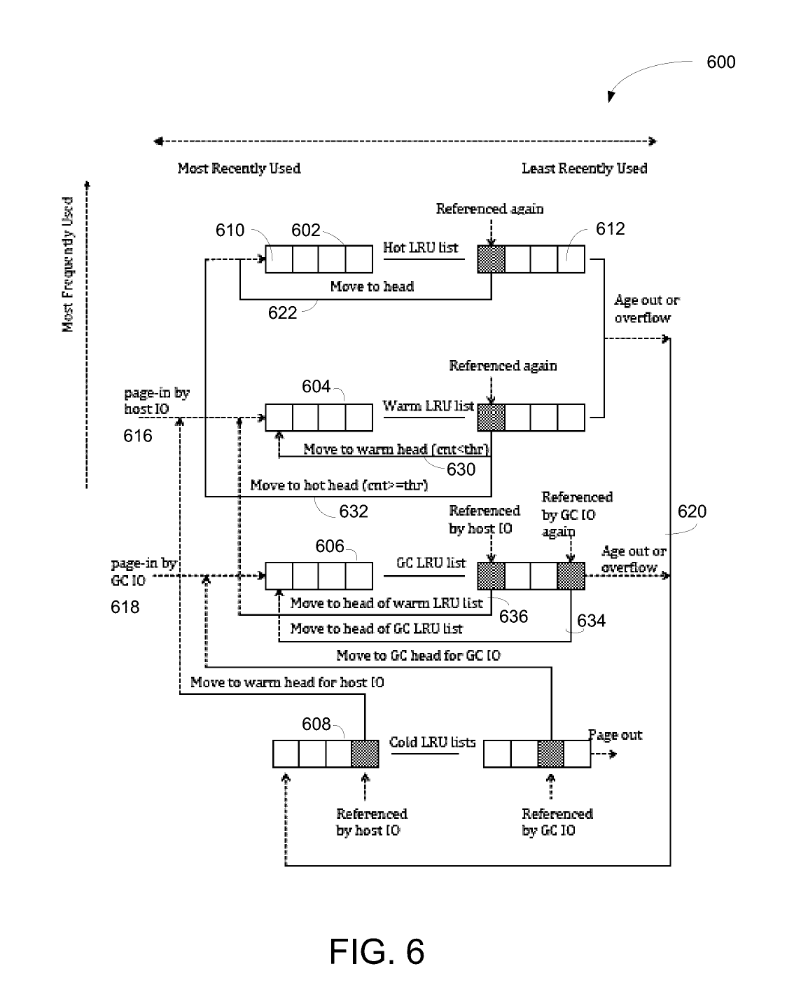

FIG. 5 is a block diagram 500 illustrating exemplary list for FTL caching operation in accordance with one embodiment of the present invention. Diagram 500 illustrates a hot LRU list 502 and a cold LRU list 504. In one aspect, the nodes of hot LRU list 502 which indicates FTL cache pages currently in RAM or cache are the most recently used pages whereby these FTL pages should be maintained in RAM. Similarly, the nodes of cold LRU list 504 which indicates FTL pages currently in RAM are less or least recently used pages whereby these FTL pages may be swapped out. It should be noted that the underlying concept of the exemplary embodiment(s) of the present invention would not change if one or more blocks (or devices) were added to or removed from diagram 500.

In one embodiment, when FTL table cache is full, a multi-level LRU linked list is used to swap out least recently used page(s) to make the room. The LRU pages or entries, in one example, are located at the tail portion of the list. The LRU linked list or list provides LRU status to all cached FTL page in RAM. The head node of the list is most recently used FTL page while the tail node of LRU list is the least recently used FTL page. One or more LRU lists may be applied based on application and workload. In each level, when one page is accessed again, it will be moved to the head of list. If one page is accessed multiple times (cache hit count>threshold), it will be moved to head of upper hotter level LRU list 502. The bottom cold LRU list 504 is an eviction list. The tail of cold list 504 will be the eviction target. Note that the tail nodes of upper level of LRU list 502 will be moved to the bottom cold LRU list 504 based age and list size. A special GC (Garbage Collection) LRU list can also be used here for handle FTL pages for garbage collection, since the garbage collection is likely handle the cold data. The purpose is to keep the most recently and frequently used page to the head of hot LRU list.

In operation, when a node is recently accessed as indicated by numeral 510, the node is moved to the front of hot LRU list 502 as indicated by numeral 516. Similarly, when a node is recently accessed in cold LRU list 504 as indicated by numeral 512, the node is moved to the front of hot LRU list 502 as indicated by numeral 508. When hot LRU list 502 overflows, the tail node of hot LRU list 502 is kicked or transferred to the head or front of cold LRU list 504 as indicated by numeral 506. When cold LRU list 504 overflows, the tail node of cold LRU list 504 is kicked out of cold LRU list 504 as indicated by numeral 518.

FIG. 6 is a block diagram 600 illustrating alternative exemplary link list for FTL caching operation in accordance with one embodiment of the present invention. Diagram 600 illustrates a hot LRU list 602, a warm LRU list 604, a GC LRU list 606, and a cold LRU list 608. In one aspect, the nodes of hot LRU list 502 which indicates the FTL pages currently in RAM are the most recently used pages whereby these FTL pages should be maintained in RAM. While warm LRU list 604 indicates the FTL pages referenced by a host device 616, GC LRU list 606 indicates the FTL pages accessed by the GC process or I/O 618. Similarly, cold LRU list 608 indicates the FTL pages that are less or the least recently used or LRU referenced pages whereby such pages are the candidates for swapping out. It should be noted that the underlying concept of the exemplary embodiment(s) of the present invention would not change if one or more blocks (or devices) were added to or removed from diagram 600.

Diagram 600 illustrates a process of four (4) levels of LRU lists wherein warm LRU list 604 is for host access and GC LRU list 606 is used for GC access. If one page inside warm LRU list 604 gets accessed again, the node is moved to the list head as indicated by numeral 630. If the cache hit count is bigger than threshold, it will be moved to the head of hot LRU list 602 as indicated by numeral 632. If one page inside GC LRU list gets accessed again, it will be moved to its head as indicated by numeral 634. If a page inside GC LRU list 606 is accessed by a host command, it will be moved to warm LRU list 604 as indicated by numeral 636. If one page inside cold LRU list 608 gets accessed again before being paged out, it will be pulled out and moved to the head of either warm LRU list 604 for host access, or GC LRU list 606 for GC access. Eventually, the head of Hot LRU list 602 contains the most frequently and recently used page. When it is time to pick an eviction page, it chooses the tail node of Cold LRU list 608. The tails of hot, warm and GC LRU lists will also be evicted to the head of cold LRU list 608 based on the age and size as indicated by numeral 620.

One embodiment of the present invention employs a fast FTL processing algorithm for achieving a fast FTL processing system. In one example, the FTL processing system is able to provide the FTL snapshot for data storage. In addition, the method provides faster FTL table recovery for the extended FTL snapshot database.

An advantage of using the FTL caching scheme is that it uses optimal amount of RAM space to efficiently cache the FTL table.

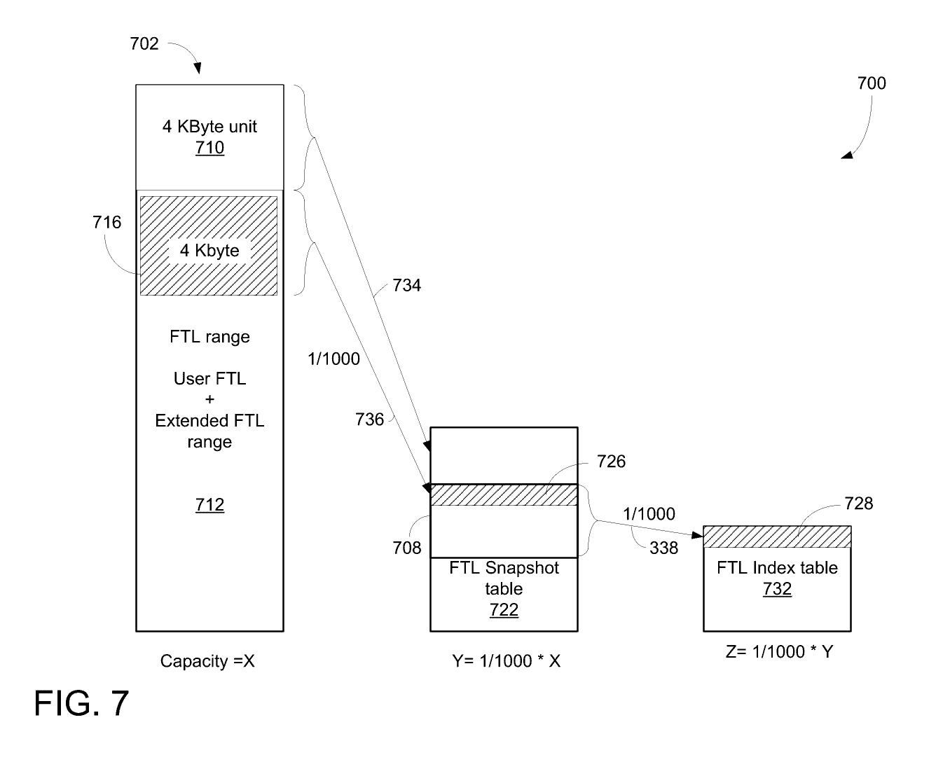

FIG. 7 is a diagram 700 illustrating an NVM storage device configured to quickly store and/or recover FTL database using an FTL index table in accordance with one embodiment of the present invention. Diagram 700 includes a storage area 702, FTL snapshot table 722, and FTL index table 732 wherein storage area 702 includes storage range 712 and an extended range 710. Diagram 700 demonstrates an exemplary relationship between NVM, FTL table, and FTL index table. Storage range 712 can be accessed by user FTL and extended FTL range. FTL snapshot table 706 is a stored FTL database at a giving time. In one embodiment, FTL snapshot table 706 is stored at extended FTL range 710 as indicated by numeral 334. It should be noted that the underlying concept of the exemplary embodiment(s) of the present invention would not change if one or more blocks (or components) were added to or removed from diagram 700.

Each entry of FTL database or FTL snapshot table such as entry 726 is set to a predefined number of bytes such as 4 bytes. Entry 726 of FTL snapshot table 722, in one example, points to 4 Kbyte data unit 716 as indicated by numeral 736. FTL snapshot table 722 is approximately 1/1024^{th} of the LBA range which includes user and extended ranges (or storage area) 712. If storage area 712 has a capacity of X, FTL snapshot table 722 is 1/1000 multiples with X. For example, if storage area 712 has a capacity of 512 gigabyte (“GB”), FTL snapshot table 722 should be approximately 512 megabyte (“MB”) which is 1/1000×512 GB.

FTL index table 732 is approximately 1/1024^{th} of FTL snapshot table 722 since each entry 728 of FTL index table 732 points to 4 Kbyte entry 708 of FTL snapshot table 722. If FTL snapshot table has a capacity of Y which is X/1000 where X is the total capacity of storage area 712, FTL index table 532 is 1/1000 multiples Y. For example, if FTL snapshot table 722 has a capacity of 512 MB, FTL index table 732 should be approximately 512 Kbyte which is 1/1000×512 MB.

In operation, before powering down the storage device, the FTL database or table is saved in FTL snapshot table 722. FTL index table 732 is subsequently constructed and stored in extended FTL range 710. After powering up the storage device, FTL index table 732 is loaded into DRAM of the controller for rebooting the storage device. Upon receiving an IO access with LBA for storage access, FTL index table 732 is referenced. Based on the identified index or entry of FTL index table 732, a portion of FTL snapshot table 722 which is indexed by FTL index table 732 is loaded from FTL snapshot table 722 into DRAM. The portion of FTL snapshot table is subsequently used to map or translate between LBA and PPA. In one aspect, FTL table or database is reconstructed based on the indexes in FTL index table 732. Rebuilding or restoring one portion of FTL database at a time can be referred to as building FTL table on demand, which improves system performance by using resources more efficiently.

An advantage of using an FTL index table is that it allows a storage device to boot up more quickly and accurately.

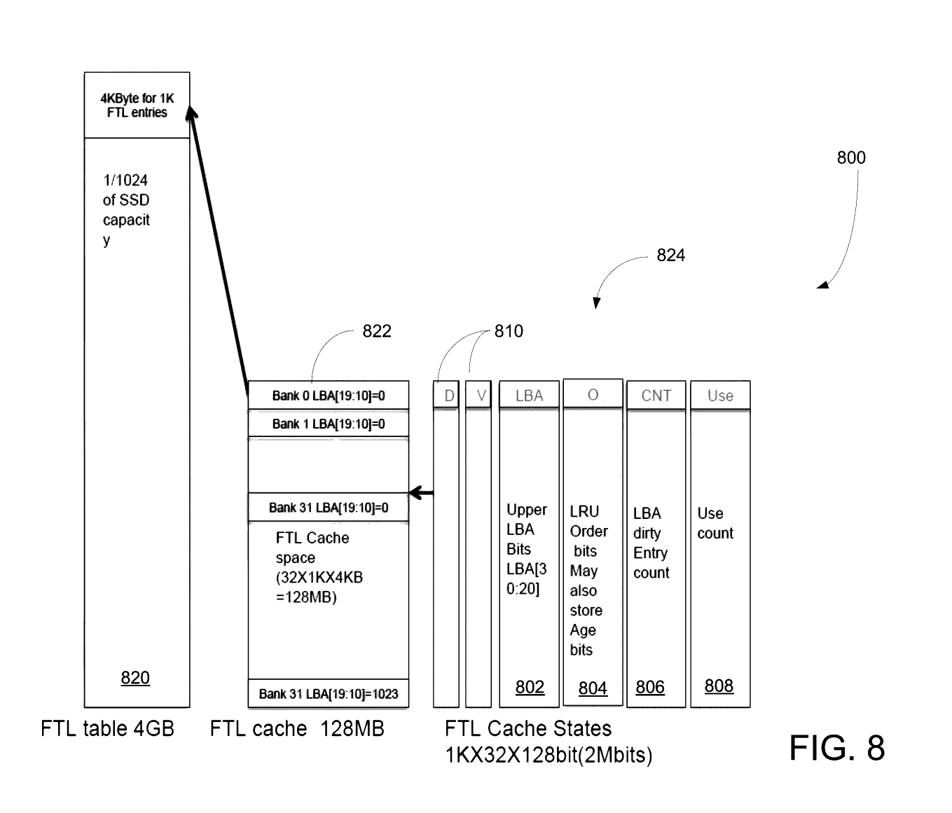

FIG. 8 is a logic diagram 800 illustrating a NVM memory process via cached FTL table entries with a set of status bits in accordance with one embodiment of the present invention. Diagram 800 includes FTL table 820, FTL cache 822, and FTL cache states 824. In one aspect, FTL cache 822 is a cache RAM capable of storing a portion of FTL table. FTL cache status 824 includes dirty bits and valid bits 810, upper LBA bits 802, LRU order bits 804, LBA dirty entry count 806, and use count 808. In one example, LRU order bits can be used to store age bits.

FTL cache approach, in one aspect, stores a reduced size of FTL table or a portion of total entries of the FTL table. For example, the same LBA[31:10] group is referred to as one LBA 1K cluster and will be snapshot at one time. The snapshot, in one example, is 4 KB which is relatively easy to read from and write to a flash memory. If FTL cache is organized to 1K×32 bank groups wherein each of the 32 bank groups is identified by LBA[19:23] which can be from 0 to 1023. When an LRU order field is used for each of the bank groups, the least recent used bank may be kicked out based on the group of usage.

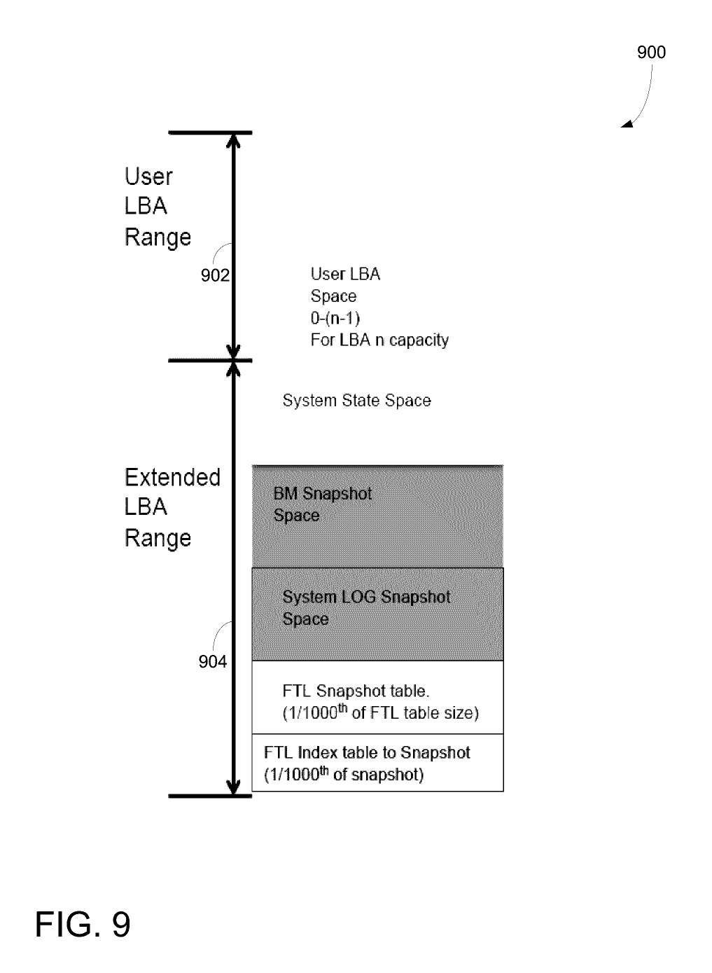

FIG. 9 is a block diagram 900 illustrating a NVM memory containing a storage area and an extended storage area in accordance with one embodiment of the present invention. Diagram 900 shows a user LBA range 902 and extended LBA range 904 wherein range 902 is used for data storage while range 904 is used for storing FTL and status. Note that FTL table snapshot and FTL log page are used for fast recovery and FTL caching operation. Extended LBA range 904, in one example, is used to store information relating to system state, BM snapshot, system log snapshot, FTL snapshot table, and FTL index table. While information relating to FTL table is used for FTL caching operation, system log snapshot and/or FTL information are used for system recovery. In order to provide a fast FTL table recovery during power up, the FTL table snapshot is saved after power down. A four (4) Kbyte of FTL segment may have an extended LBA value attached to it.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

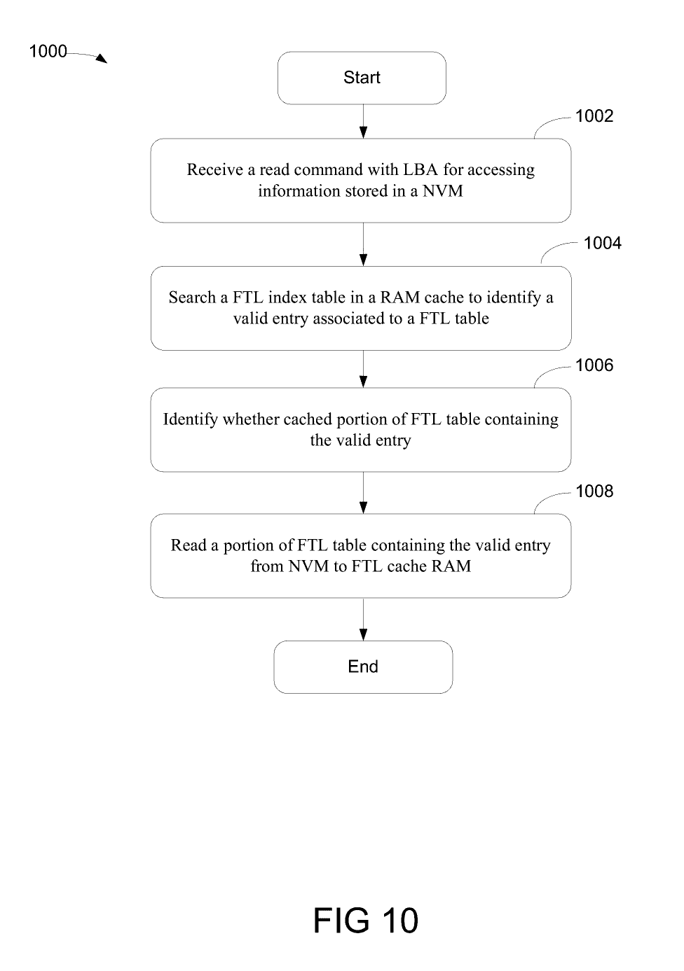

FIG. 10 is a flow diagram 1000 illustrating a cache operation for FTL table in accordance with embodiments of the present invention. At block 1002, a process capable of providing FTL caching operation receives a read command with an LBA for accessing information which is stored in NVM. The read command, in one aspect, can be issued by a host system, a GC process, and/or a swapping out process.

At block 1004, the FTL index table in RAM is searched to identify whether a valid entry associated to a FTL table according to the LBA can be found in the FTL cache table. A cache hit indicates that the FTL cache contains a PPA based on the LBA. A cache miss indicates that the entries of FTL table containing PPA based on the LBA need to be loaded from NVM to the cache (or RAM).

At block 1006, the process identifies whether the cached FTL table located in FTL cache RAM contains the valid entry in accordance with the LBA based on cache hit or cache miss.

At block 1008, a portion of FTL table containing the valid entry is read from the NVM to the FTL cache RAM in the RAM when a cache miss occurs. In one embodiment, after swapping out an FTL page pointed by the last node of cold LRU list, the process stores the newly obtained FTL pages from NVM to the FTL cache page pointed by a front list node of hot LRU list.

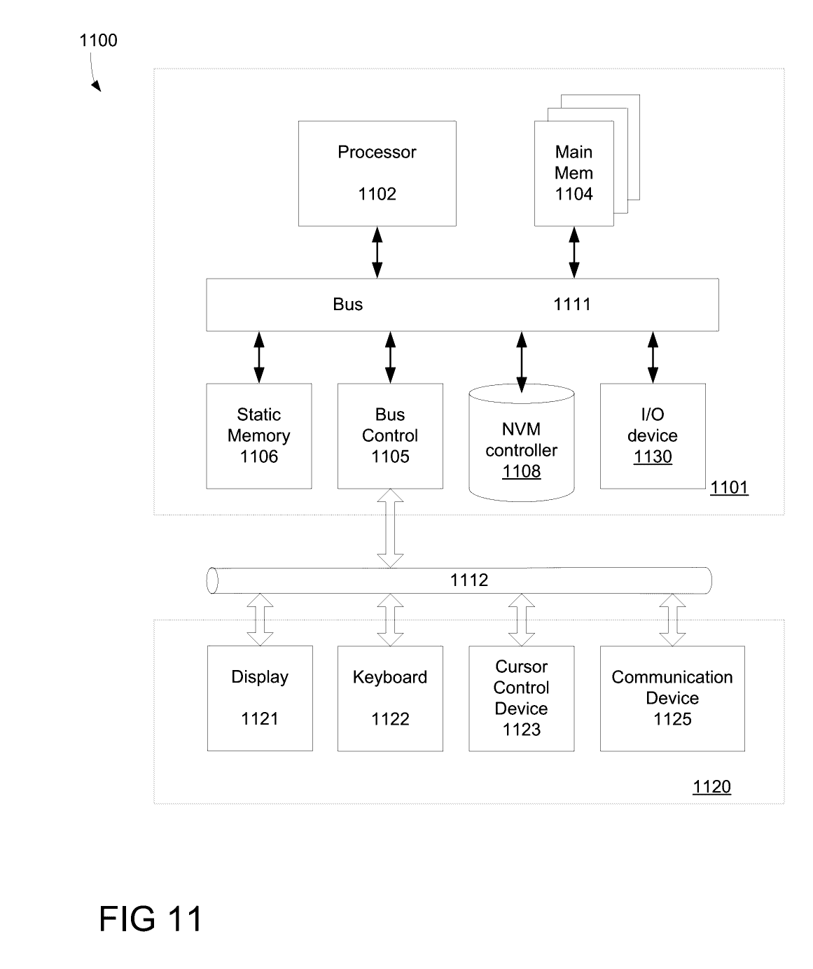

FIG. 11 shows an exemplary embodiment of a digital processing system or host system 1100 connecting to an SSD using FTL table caching operation in accordance with the present invention. Computer system or a SSD system 1100 can include a processing unit 1101, an interface bus 1111, and an input/output (“IO”) unit 1120. Processing unit 1101 includes a processor 1102, main memory 1104, system bus 1111, static memory device 1106, bus control unit 1105, I/O device 1130, and SSD controller 1108. It should be noted that the underlying concept of the exemplary embodiment(s) of the present invention would not change if one or more blocks (circuit or elements) were added to or removed from diagram 1100.

Bus 1111 is used to transmit information between various components and processor 1102 for data processing. Processor 1102 may be any of a wide variety of general-purpose processors, embedded processors, or microprocessors such as ARM® embedded processors, Intel® Core™2 Duo, Core™2 Quad, Xeon®, Pentium™ microprocessor, Motorola™ 68040, AMD® family processors, or Power PC™ microprocessor.

Main memory 1104, which may include multiple levels of cache memories, stores frequently used data and instructions. Main memory 1104 may be RAM (random access memory), PCM, MRAM (magnetic RAM), or flash memory. Static memory 1106 may be a ROM (read-only memory), which is coupled to bus 1111, for storing static information and/or instructions. Bus control unit 1105 is coupled to buses 1111-1112 and controls which component, such as main memory 1104 or processor 1102, can use the bus. Bus control unit 1105 manages the communications between bus 1111 and bus 1112.

I/O unit 1130, in one embodiment, includes a display 1121, keyboard 1122, cursor control device 1123, and communication device 1125. Display device 1121 may be a liquid crystal device, cathode ray tube (“CRT”), touch-screen display, or other suitable display device. Display 1121 projects or displays images of a graphical planning board. Keyboard 1122 may be a conventional alphanumeric input device for communicating information between computer system 1100 and computer operator(s). Another type of user input device is cursor control device 1123, such as a conventional mouse, touch mouse, trackball, or other type of cursor for communicating information between system 1100 and user(s).

Communication device 1125 is coupled to bus 1111 for accessing information from remote computers or servers through wide-area network. Communication device 1125 may include a modem or a network interface device, or other similar devices that facilitate communication between computer 1100 and the network.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A digital processing system operable to store information, comprising:
a non-volatile memory (“NVM”) organized its memory space into memory blocks for storing data persistently, each of the memory blocks divided into a plurality of physical pages addressable by corresponding physical page addresses (“PPAs”);
an address mapping table situated in the NVM and organized to include a plurality of entries for memory accessing to the NVM, each entry of the address mapping table addressed to a physical page of NVM; and
a random access memory (“RAM”) cache coupled to the NVM and configured to cache at least a portion of the address mapping table based on a table caching mechanism.

2. The system of claim 1, further comprising a cache node index table resided in the RAM cache and configured to contain indexing information to the address mapping table.

3. The system of claim 2, wherein the address mapping table is a flash translation layer (“FTL”) table containing information to facilitate identifying locations of the physical pages.

4. The system of claim 1, further comprising a memory controller coupled to the NVM and configured to provide management to the address mapping table and the RAM cache.

5. The system of claim 1, further comprising a least recently used (“LRU”) page directory coupled to the address mapping table and configured to facilitate page swapping between NVM pages dedicated to the address mapping table in the NVM and RAM pages dedicated to the address mapping table in the RAM cache.

6. The system of claim 5, wherein the LRU page directory includes a hot LRU list and a cold LRU list, wherein the hot LRU list includes recently referenced RAM pages for storing the address mapping table, wherein the cold LRU list includes less referenced RAM pages for storing the address mapping table.

7. The system of claim 6, wherein the LRU page directory further includes a garbage collection (“GC”) LRU list configured to include GC RAM pages for storing the address mapping table referenced during a GC process.

8. The system of claim 7, wherein the LRU page directory further includes a warm LRU list configured to include RAM pages for storing the address mapping table recently referenced by a host.

9. The system of claim 8, wherein last list node of the hot LRU list becomes front list node of the cold LRU list when the last list node of the hot LRU list is swapped out for making room in the host LRU list.

10. The system of claim 1, wherein the system is a solid state drive (“SSD”).

11. The system of claim 1, wherein the NVM is a flash memory based storage device.

12. The system of claim 1, wherein the NVM is a phase change memory (“PCM”) or other NVM with limited program cycles based storage device.

13. The system of claim 1, wherein the address mapping table is a physical page address (“PPA”) to logical block address (“LBA”) mapping table configured to associate between a PPA and an LBA.

14. The system of claim 1, further comprising a memory controller element able to facilitate a process of garbage collection to recycle stale pages into free pages in accordance with programming cycle count, minimum age of a block, parity check.

15. A solid state drive (“SSD”) operable to store information persistently, comprising:
a non-volatile memory (“NVM”) organized its memory space into memory blocks for storing data persistently, each of the memory blocks divided into a plurality of physical pages addressable by corresponding physical page addresses (“PPAs”), wherein the NVM includes a flash translation layer (“FTL”) table containing a set of PPAs; and
a random access memory (“RAM”) coupled to the NVM and configured to cache at least a portion of the FTL table, wherein the RAM includes a cache node index table containing index information relating to the FTL table.

16. The SSD of claim 15, further comprising a least recently used (“LRU”) page directory coupled to the address mapping table and configured to facilitate page swapping between NVM pages dedicated to the address mapping table in the NVM and RAM pages dedicated to the address mapping table in the RAM cache.

17. The SSD of claim 16, wherein the LRU page directory includes a hot LRU list and a cold LRU list, wherein the hot LRU list includes recently referenced RAM pages for storing the address mapping table, wherein the cold LRU list includes less referenced RAM pages for storing the address mapping table.

18. The SSD of claim 17, wherein the LRU page directory further includes,
a garbage collection (“GC”) LRU list configured to include GC RAM pages for storing the address mapping table referenced during a GC process; and
a warm LRU list configured to include RAM pages for storing the address mapping table recently referenced by a host.

19. A method for persistently data storage, comprising:
receiving a read command with a logical block address (“LBA”) for accessing information stored in a non-volatile memory (“NVM”);
searching a flash translation layer (“FTL”) index table in a random access memory (“RAM”) cache to identify a valid entry associated to a FTL table in response to the LBA;
identifying whether cached FTL table located in FTL cache RAM in the RAM containing the valid entry in accordance with the LBA; and
reading a portion of FTL table containing the valid entry from the NVM to the FTL cache RAM in the RAM.

20. The method of claim 19, wherein reading a portion of FTL table containing the valid entry from the NVM to the FTL cache RAM in the RAM further includes,
swapping out an FTL page pointed by last list node of a cold least recently used (“LRU”) list; and
swapping in the portion of FTL table in an FTL page pointed by a front list node of a hot LRU list.
